(19) United States
(12) Patent Application Publication
(10) Pub. No.: US 2002/0024432 A1
(43) Pub. Date: Feb. 28, 2002

(54) Method for monitoring tire pressure of pneumatic tire and device therefor

(75) Inventors: Jordan Lin, Kaohsiung (TW); Frank Kuan, Kaohsiung (TW)

Correspondence Address: LOWE HAUPTMAN GILMAN & BERNER, LLP, Suite 310, 1700 Diagonal Road, Alexandria, VA, 22314, US

(73) Assignee: LITE-ON AUTOMOTIVE CORPORATION

(21) Appl. No.: 09/910,725

(22) Filed: Jul. 24, 2001

(30) Foreign Application Priority Data
Aug. 22, 2000 (TW) 089117036

(51) Int. Cl. B60C 23/00

(52) U.S. Cl. 340/442; 340/447

(57) ABSTRACT

A method for monitoring the pneumatic tires of a vehicle, the vehicle includes a monitoring device which comprises at least one sensor module attached to a tire of the vehicle for sensing the condition of the tire and transmitting the radio frequency signal of the condition after encoded, and a decoding module comprising a radio frequency antenna module to receive the radio frequency signal transmitted by the sensor module, a memory to record the data of the predetermined range of the state of the tire and the monitored data of the condition of the tire, a processor to decode the received radio signal for comparing with the data recorded in the memory so as to decide the state of the pneumatic tire, a display device to show the state of the pneumatic tire, and a siren, the method for monitoring the pneumatic tire comprising the steps of: starting the monitor device; reading the signal of the condition of the tire sent by the sensor module and showing the state via the display device and recording the condition data of the tire transmitted by the sensor module in the memory when the vehicle is started; comparing the data of the condition of the tire and at least one predetermined range stored in the memory, if the condition is in the predetermined range, the tire is abnormal, then actuating the display to show the abnormal state and buzzing by the siren; comparing the data of the present condition of the tire with the data of the condition when the vehicle is turned off, if the difference therebetween is more than a first predetermined value, the tire is slow-leaking, then actuating the display to show the slow-leaking state and buzzing by the siren; and stopping the monitoring device.

### BACKGROUND OF THE INVENTION

1. Field of the Invention

This invention relates to a method and device for monitoring the pneumatic tires of the vehicles, and more particularly to a monitoring method and device for inspecting the condition and warning the abnormal state of each individual tire of the vehicles.

2. Description of the Related Art

In the related art, many devices are known for inspecting the pressure of the pneumatic tires of the vehicles, such as U.S. Pat. No. 5,694,111, entitled “Tire Pressure Indicator” issued on Dec. 2, 1997 to Huang, which discloses a tire pressure indicator. The tire pressure indicator is attached into the pneumatic tire and has a signal-generating device. The signal generating device includes a pressure sensing unit which generates an analog voltage signal that varies in accordance with the pressure of the tire, a signal converting unit for converting the analog voltage signal into a digital output signal, and an encoder unit for comparing the digital output signal of said signal converting unit with a predetermined normal operating pressure range and generating a radio coded signal when the digital output signal is not within the operating pressure range.

In U.S. Pat. No. 5,694,111 mentioned above, the tire pressure indicator is used to compare the pressure data that is sensed by the pressure sensor unit with the predetermined operating pressure range, and thus the abnormal state of the tire pressure will be shown. At present, most of the vehicles have been configured with the radial tires, that is, the pressure of the tire will not drop rapidly when the tire is pierced, which will facilitate the driver to drive the vehicle to the appropriate maintenance site. However, if the tire is pierced during driving, and the tire pressure does not decrease below the predetermined operation pressure range when the vehicle is parked, the indicator will not warn the driver of this state. In such case, the driver will not know this state until the vehicle is used next time. The driver shall urgently need to change the tire or call the technician.

Moreover, the tire pressure indicator is used to monitor the pressure of the individual tire, so it does not provide the appropriate device to distinguish the state of the individual tire, i.e., the indicator just actuates the alarm when the tire pressure is abnormal. Therefore, the user must further inspect the individual tire to make sure which tire is abnormal.

Therefore, the conventional tire pressure indicator is not able to show the condition of each individual tire of the vehicle. For the foregoing reasons, there is a need for a method and a device for inspecting the condition of each individual tire of the vehicle.

### SUMMARY OF THE INVENTION

It is a primary object of the present invention to provide a method for monitoring the pressure of the pneumatic tires, which can monitor the abnormal states of the pressure and the temperature of the individual tire of the vehicle.

It is a secondary object of the present invention to provide a method for monitoring the pressure of the pneumatic tires, which can distinguish the individual pneumatic tire of the vehicle to verify which tire is abnormal.

It is a further object of the present invention to provide a device for monitoring the pressure of the pneumatic tires, which can monitor the abnormal states of the pressure and the temperature of the individual tire of the vehicle.

In order to achieve the objects mentioned hereinabove, the present invention provides a device for monitoring the pneumatic tires of a vehicle which includes a monitoring device having at least one sensor module attached to a tire of the vehicle for sensing the condition of the tire and transmitting a radio frequency signal of the condition after encoded, and a decoding module comprising a radio frequency antenna module for receiving the radio frequency signal transmitted by the sensor module, a memory for recording the data of the predetermined range of the state of the tire and the monitored data of the condition of the tire, a processor for decoding the received radio signal for comparing with the data recorded in the memory so as to decide the state of the pneumatic tire, a display device for showing the state of the pneumatic tire, and a siren.

According to the present invention, the method for monitoring the pneumatic tire comprising the steps of:

providing at least one sensor module attached to a tire of the vehicle;

continuously sensing a condition of the tire, encoding the condition and transmitting a radio frequency signal of the encoded condition;

receiving the radio frequency signal of the condition and decoding the received radio signal;

reading a first data of the condition when the vehicle is started;

providing a display device for show the first data;

reading a second data of the condition after the vehicle being started; and

comparing the second data with at least one predetermined range, wherein when the condition is in the predetermined range, the tire is in a abnormal state, then actuating the display device to show the abnormal state and sounding the siren;

reading the third data of the condition when the vehicle is turned off; and

comparing a third data with the first data, wherein when the difference therebetween is more than a first predetermined value, the tire is in a slow-leaking state, then actuating the display to show the slow-leaking state and sounding the siren.

According to one aspect of the present invention, the method further comprises the step of real-time reading the data of the condition and actuating the display device to show the real-time data.

According to another aspect of the present invention, the method further comprises the steps of: reading a fourth data of the condition after the second data being read for a predetermined time period; and comparing the fourth data with the second data, wherein when the difference therebetween is more than a second predetermined value, the tire is in the slow-leaking state, then actuating the display device to show the slow-leaking state and sounding the siren.

According to still another aspect of the present invention, the method further comprises the steps of identifying the sensor module attached to the individual tire of the vehicle by means of an identifying signal sent by the sensor module when the pressure of the tire drops rapidly, and recording the relationship between the position of the tire of the vehicle and the sensor module attached thereto.

### BRIEF DESCRIPTION OF THE DRAWINGS

Other objects, advantages, and novel features of the invention will become more apparent from the following detailed description when taken in conjunction with the accompanying drawings.

FIG. 1 is a block diagram of a monitoring device according to the preferred embodiment of the present invention for monitoring the condition of the pneumatic tires.

FIG. 2 is a schematic view showing the display device of the monitoring device according to the present invention.

FIG. 3 is a flow chart showing the method for pressure monitoring of the pneumatic tires according to the present invention.

### DETAILED DESCRIPTION OF THE PREFERRED EMBODIMENTS

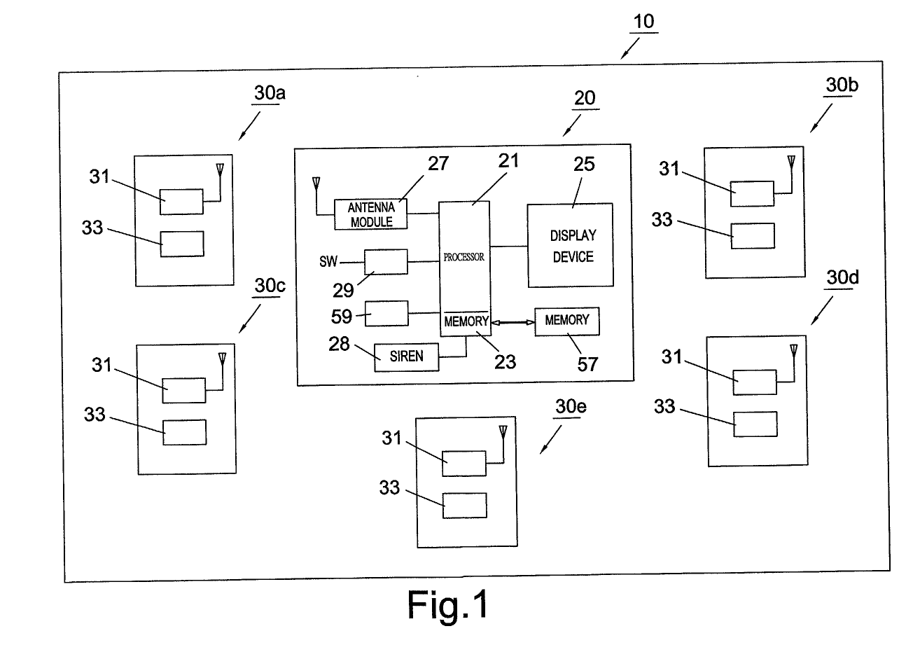

Now referring to FIG. 1, it depicts a block diagram of a monitoring device 10 according to the present invention for monitoring the condition of the pneumatic tires. The monitoring device 10 comprises a plurality of the sensor modules 30a, 30b, 30c, 30d and 30e, which are attached respectively into the pneumatic tires of a vehicle and a decoding module 20, wherein the sensor modules 30a, 30b, 30c, 30d and 30e are used to sense the tire condition which will be encoded and then transmitted by radio frequency signal.

The decoding module 20 comprises a radio frequency antenna module 27 for receiving the radio frequency signal, a memory 23 for recording the predetermined range of the normal tire condition and the monitored data of the tire condition, a processor 21 for decoding the received radio signal and comparing the decoded data with the predetermined range of the memory to decide the state of the pneumatic tire, a display device 25 for showing the state of the pneumatic tire, and a siren 28 for sounding an alarm. In a preferable embodiment according to the present invention, the condition of the tire includes the temperature and the pressure of the tire. The decoding module 20 further comprises a switch interface 29 that is connected with an ignition switch of the vehicle such that the decoding module 20 will be actuated when the vehicle is turned on and the operation of the decoding module 20 will be controlled by the ignition switch.

In a preferable embodiment according to the present invention, the monitoring device 10 comprises five sensor modules 30a, 30b, 30c, 30d and 30e respectively attached to the front-left tire, the front-right tire, the rear-left tire, the rear-right tire and the spare tire of the vehicle, which are used to monitor the condition of each tire of the vehicle.

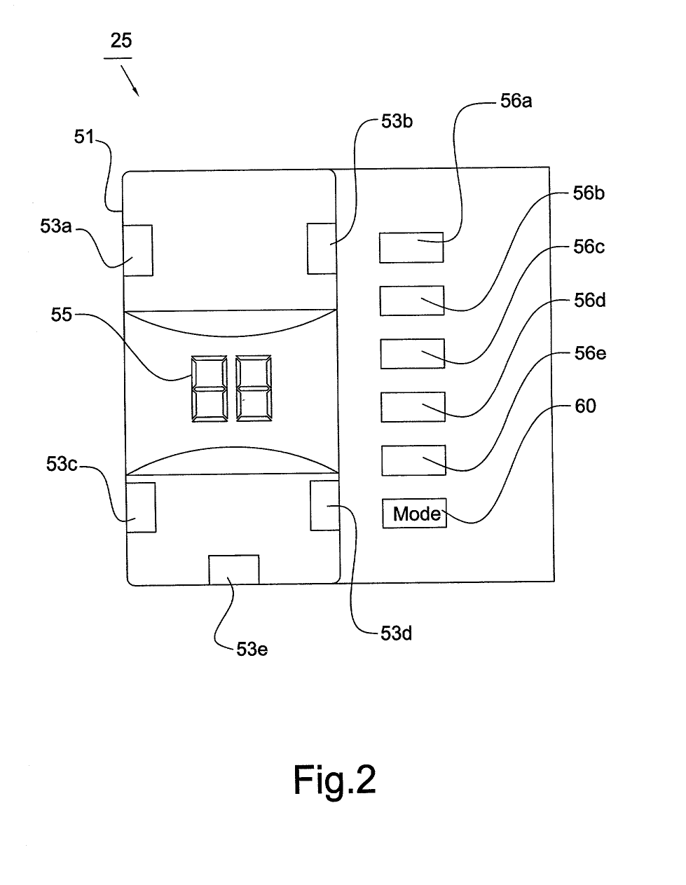

Referring to FIG. 2, the display device 25 of the decoding module 20 includes a panel 51 substantially having a vehicle shape in order to be conveniently viewed by the user, five two-color light-emitting diodes 53a, 53b, 53c, 53d and 53e, five light-emitting diodes 56a, 56b, 56c, 56d and 56e and a three-digit seven-segment light-emitting diode 55. In operation, the seven-segment light-emitting diode 55 is used to show the data of the monitored condition, the light-emitting diodes 56a, 56b, 56c, 56d and 56e are used to show the state of the tires, the five light-emitting diodes 53a, 53b, 53c, 53d and 53e are used to indicate the data and/or the state of the tires which are shown by the seven-segment light-emitting diode 55 and/or the light-emitting diodes 56a-56e, and the light-emitting diodes 53a, 53b, 53c, 53d and 53e respectively represent the front-left tire, the front-right tire, the rear-left tire, the rear-right tire and the spare tire of the vehicle. For example, if the light-emitting diode 53a was lighted or twinkled while a pressure data is shown by the seven-segment light-emitting diode 55, then the shown pressure data is the pressure data of the front-left tire. Furthermore, the display device 25 is attached to the panel of the vehicle such that the driver could conveniently and rapidly see the state of the tires of the vehicle. The light-emitting diodes 56a, 56b, 56c, 56d and 56e are used to respectively show the pressure unit, temperature unit, pressure slow-leaking, pressure quick-leaking and pressure alarm.

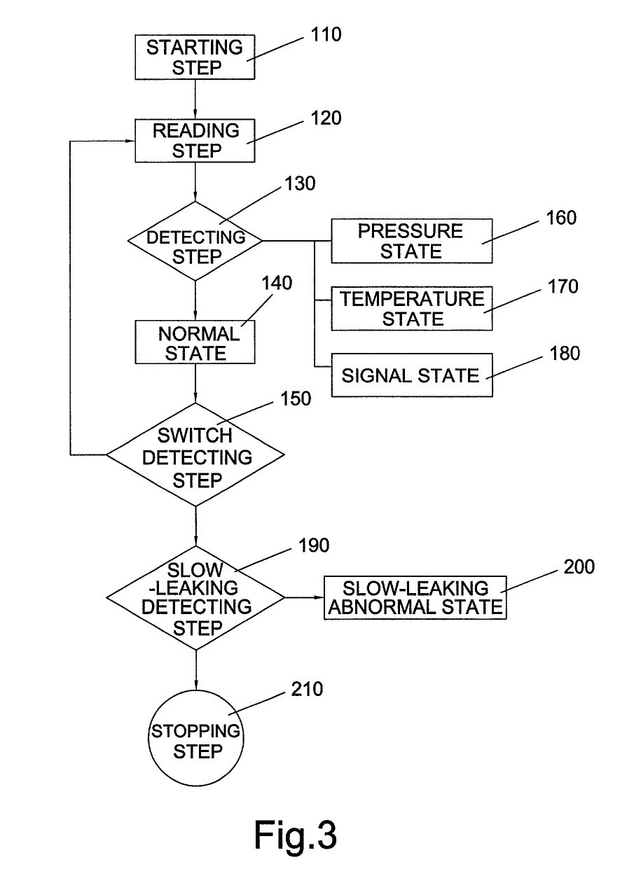

Now referring to FIG. 3, it depicts a flow chart of the monitoring method of the pneumatic tires according to the present invention. First, in step 110, when the driver turn the key ON, the light-emitting diodes 53a, 53b, 53c, 53d and 53e, the light-emitting diodes 56a, 56b, 56c, 56d and 56e and the three-digit seven-segment light-emitting diode 55 will be lighted after 4 seconds and the siren will sound for 0.3 seconds so as to test the light-emitting diodes and the siren by themselves.

Then in step 120, the decoding module 20 will receive the signal of the condition of the tires transmitted by the sensor modules 30a, 30b, 30c, 30d and 30e and light the light-emitting diodes 53a, 53b, 53c, 53d and 53e in turn, and the pressure data of the front-left tire, front-right tire, rear-left tire, rear-right tire and spare tire will be shown by the three-digit seven-segment light-emitting diode 55. After the step 120, the decoding module 20 will continue receiving the signal of the condition of the tires transmitted by five sensor modules 30a, 30b, 30c, 30d and 30e and continuously monitoring the condition of each single tire.

Then going to a step 130, the processor 21 of the decoding module 20 will compare the data of the condition of the tires transmitted by the sensor modules 30a, 30b, 30c, 30d, and 30e with the value of the predetermined range in the memory 23.

If the pressure and the temperature of each individual tire are within the predetermined range, than go to a step 140. In the step 140, if the light-emitting diodes 53a, 53b, 53c, 53d and 53e are showing green, then the conditions of the tires pressure are in normal state, the seven-segment light-emitting diode 55 is showing SAF, i.e. SAFE. After the step 140, then go to a step 150.

If the pressure of any individual tire is in abnormal state, then go to a step 160. In the step 160, the processor 21 of the decoding module 20 will control the display device 25 and the siren 28 to show a variety of the abnormal states, which comprise:

1. If the pressure is higher than 45 PSI, the pressure of the tire is too high, then the light-emitting diode of the abnormal tire will turn red and quickly twinkle for 5 seconds, the seven-segment light-emitting diode 55 will show the pressure value, the light-emitting diodes 56a and 56e will be lighted, and the siren 28 will alarm every two minutes until the abnormal state is disengaged.

2. If the pressure is between 23 PSI to 15 PSI, the pressure of the tire is slightly low, then the light-emitting diode of the abnormal tire will turn orange and slowly twinkle for 5 seconds, the seven-segment light-emitting diode 55 will show the pressure value, the light-emitting diodes 56a and 56e will be lighted and the siren 28 will alarm once.

3. If the pressure is between 15 PSI to 9 PSI, the pressure of the tire is too low, then the light-emitting diode of the abnormal tire will turn red and quickly twinkling for 5 seconds, the seven-segment light-emitting diode 55 will show the pressure value, the light-emitting diodes 56a and 56e will be lighted and the siren 28 will alarm every two minutes until the abnormal state is disengaged.

4. If the pressure is lower than 9 PSI, the pressure of the tire is seriously low, then the light-emitting diode of the abnormal tire will turn red and quickly twinkle for 30 seconds, the seven-segment light-emitting diode 55 will show the pressure value, the light-emitting diodes 56a and 56e are lighted and the siren 28 will alarm. In that case the abnormal tire should be changed with the spare tire, so the siren will alarm just once to avoid intruding upon the driver.

If the above mentioned four states are not disengaged, the monitoring device 10 according to the present invention will warn the driver again that the problem of the tire still exists when the vehicle is turned on every time.

5. If the pressure decreases rapidly (the pressure drops more than about 3 PSI per minute), the light-emitting diode of the abnormal tire will turn red and quickly twinkle for 30 seconds, the seven-segment light-emitting diode 55 will show the pressure data, the light-emitting diodes 56a and 56e will be lighted and the siren 28 will alarm, and after 30 seconds, if the pressure drops more than 1 PSI, the siren will keep alarm until the pressure stop decreasing.

6. If the pressure decreases slowly (for example, the pressure drops more than 1 PSI per 10 minutes, and/or the pressure drops more than 1.4 PSI after the vehicle is turned on), then the light-emitting diode of the abnormal tire will turn orange, and the seven-segment light-emitting diode 55 will show the pressure value, the light-emitting diodes 56a, 56c and 56e will be lighted to indicate that the tire is leaking slowly and the siren 28 will alarm.

If the temperature of any individual tire is abnormal, go to a step 170. In the step 170, the processor 21 of the decoding module 20 will control the display device 25 and the siren 28 to show a variety of the abnormal temperature states, which comprise:

If the temperature is higher than 85° C., the temperature of the tire is too high, then the light-emitting diode of the abnormal tire will turn red and quickly twinkle for 5 seconds, the seven-segment light-emitting diode 55 will show the temperature value, the light-emitting diodes 56b will be lighted, and the siren 28 will alarm every two minutes until the abnormal temperature state is disengaged.

If the antenna module 27 of the decoding module 20 dose not receive the signal which is sent by the individual sensor modules 30a, 30b, 30c, 30d, and 30e for ten times, then go to a step 180. In the step 180, the processor 21 of the decoding module 20 will show NOS by means of the seven-segment light-emitting diode 55 to indicate the state of “no signal”, i.e. no signal sent from the tire, thus the tire has some problems or the battery is dead.

In the step 150, the switch interface of the decoding module 20 connected to the ignition switch can be used to sense whether the ignition switch of the vehicle is turned off or not. If the ignition switch of the vehicle is still on, then go to the step 120 again to read the signals of the condition of the tires sent by the sensor modules 30a, 30b, 30c, 30d and 30e. If the ignition switch of the vehicle is turned off, then go to the step 190 to monitor the slow-leaking state of the vehicle tires.

In the step 190, the decoding module 20 will compare the present pressure of each individual tire with the pressure of each individual tire when the ignition of the vehicle was turn on. If the pressure of any tires drops more than 1.4 PSI, the tire is slow-leaking, then go to a step 200;and if the pressure of every tire drops less than 1.4 PSI, then go to a step 210. In step 200, the processor 21 of the decoding module 20 will control the display device 25 and the light-emitting diode of the abnormal tire to turn orange, the seven-segment light-emitting diode 55 to show the real pressure data, the light-emitting diodes 56a, 56c and 56e to be lighted, and to warn with sounding the siren 28 to remind the driver of the slow-leaking state of the tires of the vehicle that needs to be pay attention to. In step 210, the method for pressure monitoring of pneumatic tires of the vehicle is finished.

As mentioned above, the device 10 according to the present invention is used to monitor the condition of the pneumatic tires of the vehicles and show the state of each individual abnormal tire. The device 10 should be able to identify the signal of the tire condition sent by the sensor modules 30a, 30b, 30c, 30d and 30e. Therefore, the monitoring device of the pneumatic tires of the vehicles according to the present invention further comprises a function of learning.

The sensor modules 30a, 30b, 30c, 30d and 30e are attached to the individual tires of the vehicle and each has a sensor application-specific integrated circuit (ASIC) 33 and the radio frequency circuit 31, in which the ASIC can be an integrated circuit of the model No. IB01290 manufactured by the LITEON Inc. Each of tires has one sensor module attached therein, the sensor application-specific integrated circuit 33 of the sensor module will send the data including the pressure and temperature of the tire to the radio frequency circuit 31 per minute, and the sent data including the pressure and temperature of the tire will be transmitted by the radio frequency circuit 31. When the pressure drops rapidly in excess of about 3 PSI/Second, the sensor module will transmit frequently the data to the radio frequency circuit 31 about 256 times every 0.85 second. The decoding module 20 further comprises a memory 57 for recording the specific code which is sent by the sensor application-specific integrated circuit 33 so as to identify the sensor application-specific integrated circuit 33 being attached to the individual tire.

The learning method will take advantage of the functions of the sensor application-specific integrated circuit 33 to avoid confusing the sensor module with the one of the other vehicle. The sensor application-specific integrated circuit 33 is comprised of pressure and temperature sensor, microprocessor and computing amplifier.

When the user turns the key of the vehicle in the order of on-off-on-off-on-off-on, the decoding circuit 20 starts the learning process.

Now the light-emitting diode 53a (representing the front-left tire) turns red, the seven-segment light-emitting diode 55 shows 001, while the front-left tire will be evacuated in excess of 3 PSI, then the sensor module will send signals continually. If the decoding circuit 20 receives continually three of the same identical code, the siren will sound for 1 second, the learning process of the front-left tire will be accomplished. The decoding circuit 20 will light the light-emitting diodes 53a, 53b, 53c, 53d and 53e in red sequentially, the seven-segment light-emitting diode will show 01, 02, 03, 04 and 05, while the front-left tire, the front-right tire, the rear-left tire, the rear-right tire and the spare tire will be evacuated in excess of 3 PSI, respectively, so as to accomplish the learning process of each individual tire. If the learning process is accomplished, then the light-emitting diodes 53a, 53b, 53c, 53d and 53e will turn green. If the learning process of anyone of the five tires can not be accomplished in 50 seconds, the learning process fails and it has to be restarted.

When the user turns the key of the vehicle in the order of on-off-on-off-on-off-on and presses a mode button 60 on the decoding modules 20, the decoding circuit 20 will go into the unit-converting mode, the seven-segment light-emitting diode 55 shows 111, then the pressure unit is PSI, the temperature unit is ° C. If the user presses the mode button 60 once again, the seven-segment light-emitting diode 55 will show 222, then the pressure unit is PSI, the temperature unit is ° F. If the user presses the mode button 60 once again, then the seven-segment light-emitting diode 55 will show 333, then the pressure unit is Bar or Kgf/cm², the temperature unit is ° C. If the user presses the mode button 60 once again, the seven-segment light-emitting diode 55 will show 444, then the pressure unit is Kpa, the temperature unit is ° C. If the user presses the mode button 60 once again, the seven-segment light-emitting diode 55 will show 555, then the pressure unit is Bar or Kgf/cm², the temperature unit is ° F. If the user presses the mode button 60 once again, the seven-segment light-emitting diode 55 will show 666, then the pressure unit is Kpa, the temperature unit is ° F.

When the user turns the key of the vehicle in the order of on-off and turns the switch of the indoor lights in the order of on-off-on, the decoding circuit 20 will go into the alert level set mode, the seven-segment light-emitting diode 55 shows HI and then shows 45(i.e. 45 PSI; the high level of the pressure), and this value of the high level can be varied by pressing the mode button 60 from 40 to 55 PSI. For example, the users can press the mode button 60 to increase the value with 1 PSI each time form 45 to 55, then jump to 40 and cycle form 40 to 55 until the user determines the value. Then if the user turns the switch of the indoor lights in the order of off-on again, the seven-segment light-emitting diode 55 shows LO1 and then shows 23(i.e. 23 PSI; the first low level of the pressure), and this value can be varied by pressing the mode button 60 from 20 to 35 PSI. Then if the user turns the switch of the indoor lights in the order of off-on more again, the seven-segment light-emitting diode 55 shows L02 and then shows 15(i.e. 15 PSI; the second low level of the pressure), and this value can be varied by pressing the mode button 60 from 10 to 23 PSI. When the user turns the switch of the indoor lights off, then the decoding circuit 20 will exit the alert level set mode.

Moreover, as mentioned above, the device 10 used to monitor the condition of the pneumatic tires of the vehicles according to the present invention will show the condition of each individual tires by means of the display device 25 of the decode module 20. Therefore, the ambient light will influence the display device 25 to display the condition, so the monitoring device 10 for pneumatic tire according to the present invention further comprises a light control device connected to the indoor-light controller of the vehicle so as to adjust the illumination of the display device 25.

Although the invention has been explained in relation to its preferred embodiment, it is to be understood that many other possible modifications and variations can be made without departing from the spirit and scope of the invention as hereinafter claimed.

What is claimed is:

1. A method for monitoring the pneumatic tires of a vehicle comprising the steps of:
providing at least one sensor module attached to a tire of the vehicle;
continuously sensing a condition of the tire, encoding the condition and transmitting a radio frequency signal of the encoded condition;
receiving the radio frequency signal of the condition and decoding the received radio signal;
reading a first data of the condition when the vehicle is started;
providing a display device for showing the first data;
reading a second data of the condition after the vehicle being started; and
comparing the second data with the first data, wherein when the difference therebetween is more than a predetermined value, the tire is in a slow-leaking state, then actuating the display to show the slow-leaking state and sounding the siren.

2. The method for monitoring the pneumatic tires of a vehicle as claimed in claim 1, further comprising the steps of:
reading a third data of the condition after the second data being read for a predetermined time period;
comparing the third data with the second data, wherein when the difference therebetween is more than the predetermined value, the tire is in the slow-leaking state, then actuating the display device to show the slow-leaking state and sounding the siren.

3. The method for monitoring the pneumatic tires of a vehicle as claimed in claim 2, wherein the condition of the tire is pressure.

4. The method for monitoring the pneumatic tires of a vehicle as claimed in claim 3, wherein the predetermined value is 1.4 PSI, and the predetermined time period is 10 minutes.

5. The method for monitoring the pneumatic tires of a vehicle as claimed in claim 1, further comprising the step of:
real-time reading the data of the condition and actuating the display device to show the real-time data.

6. A method for monitoring the pneumatic tires of a vehicle comprising the steps of:
providing at least one sensor module attached to a tire of the vehicle;
continuously sensing a condition of the tire, encoding the condition and transmitting a radio frequency signal of the encoded condition;
receiving the radio frequency signal of the condition and decoding the received radio signal;
reading a first data of the condition when the vehicle is started;
providing a display device for show the first data;
reading a second data of the condition after the vehicle being started; and
comparing the second data with at least one predetermined range, wherein when the condition is in the predetermined range, the tire is in a abnormal state, then actuates the display device to show the abnormal state and sounds the siren;
reading the third data of the condition when the vehicle is turned off; and
comparing a third data with the first data, wherein when the difference therebetween is more than a first predetermined value, the tire is in a slow-leaking state, then actuating the display to show the slow-leaking state and sounding the siren.

7. The method for monitoring the pneumatic tires of a vehicle as claimed in claim 6, further comprising the step of:
real-time reading the data of the condition and actuating the display device to show the real-time data.

8. The method for monitoring the pneumatic tires of a vehicle as claimed in claim 6, further comprising the steps of:
reading a fourth data of the condition after the second data being read for a predetermined time period; and
comparing the fourth data with the second data, wherein when the difference therebetween is more than a second predetermined value, the tire is in the slow-leaking state, then actuates the display device to show the slow-leaking state and sounds the siren.

9. The method for monitoring the pneumatic tires of a vehicle as claimed in claim 6, further comprising the step of:
comparing the second data with the first data, wherein when the difference therebetween is more than the first predetermined value, the tire is in the slow-leaking state, then actuates the display device to show the slow-leaking state and sounds the siren.

10. The method for monitoring the pneumatic tires of a vehicle as claimed in claim 8, wherein the condition of the tire comprises pressure.

11. The method for monitoring the pneumatic tires of a vehicle as claimed in claim 9, wherein the condition of the tire comprises pressure.

12. The method for monitoring the pneumatic tires of a vehicle as claimed in claim 6, wherein the first predetermined value is 1.4 PSI.

13. The method for monitoring the pneumatic tires of a vehicle as claimed in claim 8, wherein the predetermined time period is 10 minutes, and the second predetermined value is 1 PSI.

14. The method for monitoring the pneumatic tires of a vehicle as claimed in claim 6, wherein the predetermined range is more than 45 PSI for representing that the pressure of the tire is too high.

15. The method for monitoring the pneumatic tires of a vehicle as claimed in claim 6, wherein the predetermined range is from 23 PSI to 15 PSI for representing that the pressure of the tire is slightly low.

16. The method for monitoring the pneumatic tires of a vehicle as claimed in claim 6, wherein the predetermined range is from 15 PSI to 9 PSI for representing that the pressure of the tire is too low.

17. The method for monitoring the pneumatic tires of a vehicle as claimed in claim 6, wherein the predetermined range is less than 9 PSI for representing that the pressure of the tire is seriously low, and the display device and the siren will be actuated to warn only once so as to avoid interfering the driver after the spare tire being changed.

18. The method for monitoring of pneumatic tires of a vehicle as claimed in claim 6, wherein the condition of the tire comprises temperature.

19. The method for monitoring the pneumatic tires of a vehicle as claimed in claim 18, wherein the predetermined range is more than 85° C. for representing that the temperature of the tire is too high.

20. The method for monitoring the pneumatic tires of a vehicle as claimed in claim 6, further comprising the steps of:
identifying the sensor module attached to the individual tire of the vehicle by mean of a identifying signal sent by the sensor module when the pressure of the tire drops rapidly; and
recording the relationship between the position of the tire of the vehicle and the sensor module attached thereto.

21. The method for monitoring the pneumatic tires of a vehicle as claimed in claim 20, wherein the identifying step is controlled by the operation of the key of the vehicle.

22. A device for monitoring the pneumatic tires of a vehicle, comprising:
at least one sensor module attached to a tire of the vehicle used to sense a condition of the tire and transmit the radio frequency signal of the encoded condition; and
a decoding module comprising:
a radio frequency antenna module for receiving a radio frequency signal which is sent by the sensor module;
a memory for recording the data of a predetermined range of the tire using state and the monitored data of the condition of the tire;
a processor for decoding the received radio signal and comparing the data of the memory therewith to decide the using state of the pneumatic tire;
a display device for showing the using state of the pneumatic tire; and
a siren,
wherein the monitoring device can be used for monitoring the condition of the tire to which the sensor module is attached and is controlled by the operation of the key of the vehicle, and the monitoring device can be used for comparing the present condition of the tire with the condition of the tire when the vehicle is turned on, wherein when the difference therebetween is more than a first predetermined value, then the tire is in a slow-leaking state.

23. The monitoring device as claimed in claim 22, wherein the monitoring device can be used for comparing the conditions of the tire for a predetermined time period, wherein when the difference therebetween is more than a second predetermined value, then the tire is in the slow-leaking state.

24. The monitoring device as claimed in claim 22, wherein the condition of the tire is pressure.

25. The monitoring device as claimed in claim 24, wherein the first predetermined value is 1.4 PSI.

26. The monitoring device as claimed in claim 24, wherein the predetermined period is 10 minutes, and the second predetermined value is 1.0 PSI.

27. The monitoring device as claimed in claim 22, wherein the sensor module of the monitoring device will transmit continuously a signal when the pressure of the tire drops rapidly, and the signal includes the identifying codes of the sensor module whereby the monitoring device can identify the relationship between the position of the tire of the vehicle and the sensor module attached thereto.

28. The monitoring device as claimed in claim 27, wherein the monitoring device further comprises a memory to record the identifying code that is sent by the sensor module.

29. The monitoring device as claimed in claim 22, wherein the monitoring device further comprises a light control device connected to the indoor-light controller of the vehicle so as to adjust the illumination of the display device.

30. The monitoring device as claimed in claim 22, wherein the monitoring device further comprises a display control device to controllably show the condition of the tire of the vehicle.

31. The monitoring device as claimed in claim 22, wherein the monitoring device further comprises an abnormal state display device to show the abnormal state of the tire of the vehicle.
